(19) United States
(12) Patent Application Publication
(10) Pub. No.: US 2014/0122321 A1
(43) Pub. Date: May 1, 2014

(54) METHODS AND SYSTEMS RELATED TO LENDER MATCHING

(71) Applicant: Gordon*Howard Associates, Inc., Littleton, CO (US)

(72) Inventors: Gerald A. Morgan, Littleton, CO (US); Alan Vordermeier, JR., Wellington, FL (US); Gary A. Pierce, Fort Mill, SC (US)

(73) Assignee: Gordon*Howard Associates, Inc., Littleton, CO (US)

(21) Appl. No.: 14/026,899

(22) Filed: Sep. 13, 2013

Related U.S. Application Data
(60) Provisional application No. 61/700,664, filed on Sep. 13, 2012.

(51) Int. Cl. G06Q 40/02

(52) U.S. Cl. CPC G06Q 40/025
USPC 705/38

(57) ABSTRACT

Lender Matching. At least some of the various embodiments are methods including: receiving, by a computer system, a loan application submitted by a borrower; creating, by the computer system, a lender score for each lender of a group of lenders, each lender score based on information within the loan application and a set of criteria provided by each lender of the group of lenders; sending, by the computer system, the loan application to a predetermined number of lenders of the group of lenders, the lenders to whom the loan application is sent selected based on the lender score of each lender, and the predetermined number being less than all the lenders in the group of lenders.

### CROSS-REFERENCE TO RELATED APPLICATIONS

This application claims the benefit of provisional application Ser. No. 61/700,664 filed Sep. 13, 2012, titled “Methods and Systems Related to Lender Matching”, which provisional application is incorporated by reference herein as if reproduced in full below.

### BACKGROUND

In the financial world, some companies are in the business of providing sales leads to other companies, and thus may be referred to as “lead providers.” One example of a lead provider is LendingTree, LLC (of Charlotte, N.C.) which operates under the LENDINGTREE® trademark. LendingTree accepts loan applications for products such as home loans, car loans, and credit cards. LendingTree does not itself loan money, but instead provides the loan information to lenders. Thus, LendingTree provides sales leads to the lenders and is considered a lead provider.

Like any business, lead providers are in the business to make money, and thus the sales leads are not provided for free. Rather, the sales leads are sold to interested companies. However, many of the sales leads sold today are invalid for a variety of reasons. Companies that purchase sales leads from lead providers are therefore paying for many sales leads that are invalid. Thus, any process that increases the probability of a sales lead leading to an actual sale of a product or service would be beneficial.

### BRIEF DESCRIPTION OF THE DRAWINGS

For a detailed description of exemplary embodiments of the invention, reference will now be made to the accompanying drawings in which:

FIG. 1 shows, in block diagram form, a plurality of entities involved in lender matching in accordance with at least some embodiments;

FIG. 2 shows, in block diagram form, a flow of information between entities in accordance with at least some embodiments;

FIG. 3 shows, in block diagram form, a flow of information between entities in accordance with at least some embodiments;

FIG. 4 shows, in block diagram form, a flow of information between entities in accordance with at least some embodiments;

FIG. 5 shows, in block diagram form, a flow of information between entities in accordance with at least some embodiments;

FIG. 6 shows, in block diagram form, a flow of information between entities in accordance with at least some embodiments;

FIG. 7 shows, in block diagram form, an example system environment in accordance with at least some embodiments;

FIG. 8 shows, in flow diagram form, a method in accordance with at least some embodiments; and

FIG. 9 shows, in block diagram form, an example computer system in accordance with at least some embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection.

“Remote” shall mean one kilometer or more.

“Borrower” shall mean a legal entity (e.g., person, corporation) who seeks to borrow money for the purchase of a product (e.g., vehicle, home) or to obtain credit (e.g., for a credit card, home improvement loan). Failure to obtain borrowed funds shall not obviate status as a borrower.

“Lender” shall mean a legal entity (e.g., person, corporation) who seeks to loan money to a borrower. A decision not to loan money to a borrower shall not obviate status as a lender.

“Lender score” shall mean a value indicative of how well a borrower meets predetermined lending criteria of a lender.

“Threshold criterion” shall mean a criterion that, if not met by a borrower, will preclude a lender from loaning money to the borrower (e.g., recent bankruptcy, has not lived at current address more than six months). The plural of “threshold criterion” shall be threshold criteria.

“Creating . . . a lender score for each lender of a group of lenders” shall mean that a plurality of lender scores is created, each lender score (of the plurality of lender scores) associated with a respective lender.

“A set of criteria provided by each lender” shall mean that a plurality of sets of criteria are provided, with at least one set of criteria provided from each lender.

“Range criteria”, with respect to a lender, shall mean a range of values.

“Debt-to-income (DTI) ratio” shall mean a ratio of monthly income of a borrower used to pay debts to gross income of the borrower. DTI ratio may also be expressed as a percentage.

“Front end debt-to-income ratio” shall mean a ratio of monthly income that is used for housing costs to gross income, where housing costs may include: rent; mortgage payments, including principal, interest, and private mortgage insurance; insurance premiums; property taxes; and homeowners association fees. Front end debt-to-income ratio may also be express as a percentage.

“Back end debt-to-income ratio” shall mean a ratio of monthly income used for all recurring debt payments to gross income, the recurring debt payments including those of the front end debt-to-income ratio. The recurring debts may include: credit card payments; car loan payments; student loan payments; child support payments; alimony payments; and legal judgment payments. Front end debt-to-income ratio may also be express as a percentage.

“Lead” shall mean a loan application related to a borrower.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

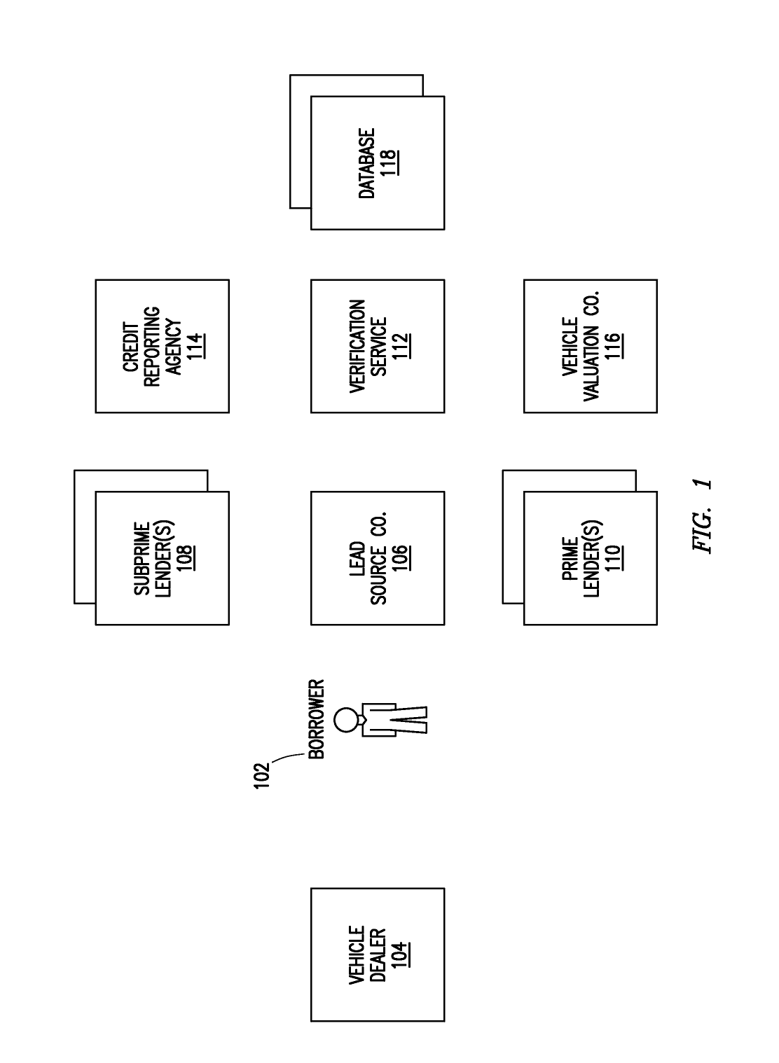

Various embodiments are directed to systems and methods of validating and matching leads with lending institutions (i.e., lenders). The various embodiments were developed in the context of matching lenders with borrowers seeking vehicle purchase loans or vehicle refinance loans, and thus the specification will be based on the development context; however, the developmental context shall not be read as a limitation as to the applicability of the various embodiments, as the methods described herein may apply to other lender/borrower situations. The specification first turns to a high level overview. FIG. 1 shows, in block diagram form, the various entities involved in matching a borrower to at least one lending institution.

Overview

In one embodiment, a borrower 102 wants to purchase a vehicle from a dealership 104. In order to purchase the vehicle, the borrower 102 seeks financing for a vehicle purchase loan. Depending on the borrowers financial situation, the borrower 102 may be seeking financing from a subprime lender 108 or a prime lender 110. Subprime lender 108 may be a type of financing institution which provides financing to borrowers who have difficulty maintaining a repayment schedule due to a number of issues, such as debt and/or a low monthly income. Subprime lenders may have lower threshold criteria in agreeing to provide financing to a borrower. In contrast, prime lender 110 may be a type of financing institution which provides financing to borrowers who appear to be low-risk, and thus more likely to repay the loan amounts. Prime lenders may thus have higher threshold criteria for agreeing to provide financing.

In order to matching borrower 102 with lenders (such as subprime lender 108 or prime lender 110), a lead source company 106 may provide a lender matching service. A lead is created when borrower 102 fills out an application to obtain financing, and provides the application to the lead source company 106. In some cases, the borrower 102 may provide the application to the lead source company 106 electronically, such as over the Internet. In other cases, the borrower 102 may provide the application over the phone by calling a customer service representative of the lead source company 106.

Regardless of the precise mechanism by which the lead source company 106 receives the application, the lead source company may perform filtering and validation of the lead using information received from a plurality of third-party service providers, such as a verification service 112, credit reporting agency 114, and vehicle valuation company 116. Assuming the lead meets the initial criteria and quality criteria of the lead source company 106 (discussed more below), the lead is “matched” with one or more lenders. Each lender with whom the lead has been matched receives the lead from the lead source company 106. Each lender to whom the lead is provided may then contact the borrower 102 in an attempt to close the loan and, in the example case of the borrower 102 seeking financing for a car loan, provide the funding to the vehicle dealer 104.

The specification turns now to a more detailed discussion of the lenders providing the lead source company 106 a set of criteria by which the lender matching may occur.

Lenders Provide Desired Criteria

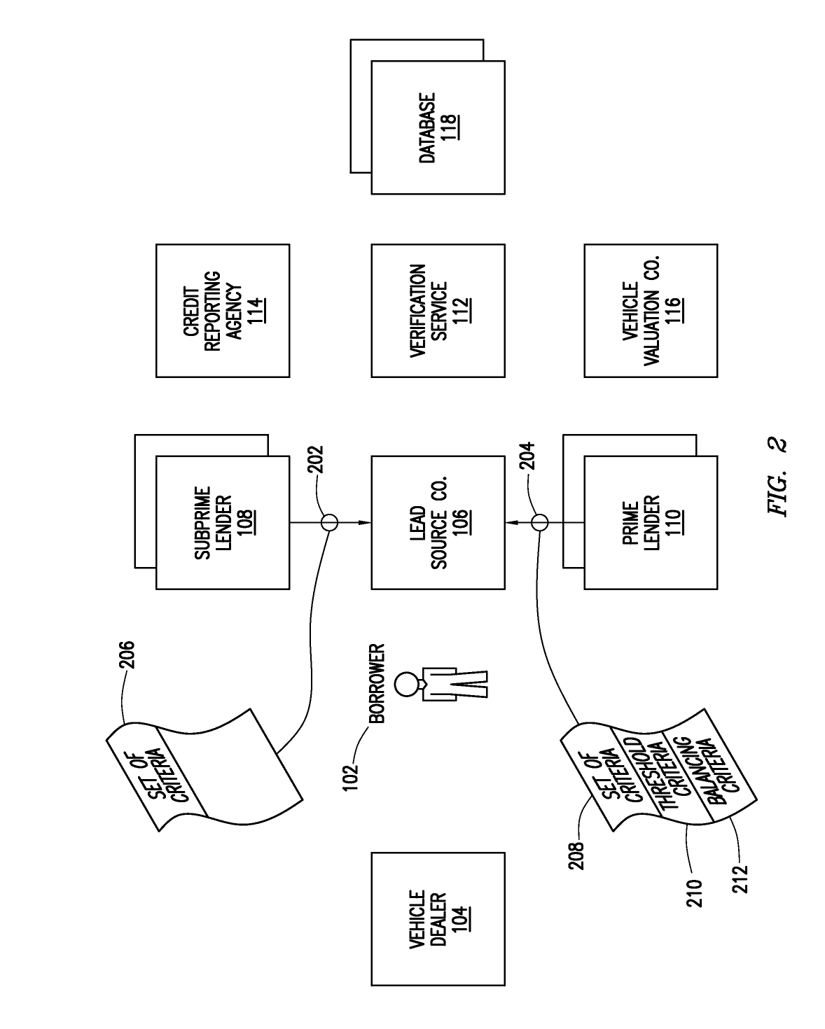

FIG. 2 shows, in block diagram form, the system of FIG. 1 modified to show flow of information from the example lenders (subprime lender 108 and/or prime lender 110) to the lead source company 106. In particular, in example cases, prior to the borrower 102 contacting the lead source company 106, each lender may provide a set of criteria to the lead source company 106 regarding each lending institution's requirements and considerations regarding financing the borrower 102. Providing the set of criteria 206 by subprime lender 108 is shown by arrow 202. Providing the set of criteria 208 by prime lender 110 is shown by arrow 204. Each set of criteria may be conceptually divided into two components, illustratively shown with respect to the set of criteria 208 as threshold criteria 210 and balancing criteria 212.

A threshold criterion is a criterion that, if not met by the borrower 102, precludes the lender from loaning money to or financing the borrower. For example, some lenders may refuse to loan money to or finance borrowers when: the borrower has had a recent bankruptcy; the borrower has not lived at the current address more than six months; the borrower has a credit score below a certain threshold; the borrower has worked at the current place of employment less than a predetermined amount of time; the borrow has collateral or liquid assets below a predetermined amount; the borrower's monthly financial obligations exceed a predetermined threshold; the borrowers total monthly income is below (or above) a predetermined threshold; the loan amount is above or below predetermined thresholds; the size of the down payment is less than a predetermined threshold; the borrower's front debt-to-income ratio is above a predetermined value or percentage; the borrower's back debt-to-income ratio is above a predetermined values or percentage; or the lender does not partake in a particular loan type. Thus, a lender may have more than one threshold criterion, referred to as a group as threshold criteria.

Beyond the threshold criteria, a lender may also have balancing criteria. That is, certain criterion of the lender may span a range of values, with the lender more interested in a borrower when the borrower is closer to one end of the range than the other end of the range. For example, some lenders may loan money to or finance borrowers when a borrower has lived at the current address at least six months, but the longer the borrower has lived at the current address, the more attractive the borrower is to the lender. As another example, some lenders may loan money to or finance borrowers when a borrower has worked at the current place of employment for at least a predetermined amount of time, but the longer the borrower has worked at the current place of employment, the more attractive the borrower is to the lender. As yet another example, some lenders may loan money or finance borrowers when a borrower has no greater than certain debt-to-income ratio, and the lower the ratio of the borrower, the more attractive the borrower is to the lender.

Thus, a particular borrower may meet the threshold criteria, and the suitability of the borrower to the lender may be gauged on a sliding scale based on where on the scale the borrower exists with respect to various balancing criteria. The specification now turns to receiving a lead from the borrower.

Borrower Provides Lead to Lead Source Company

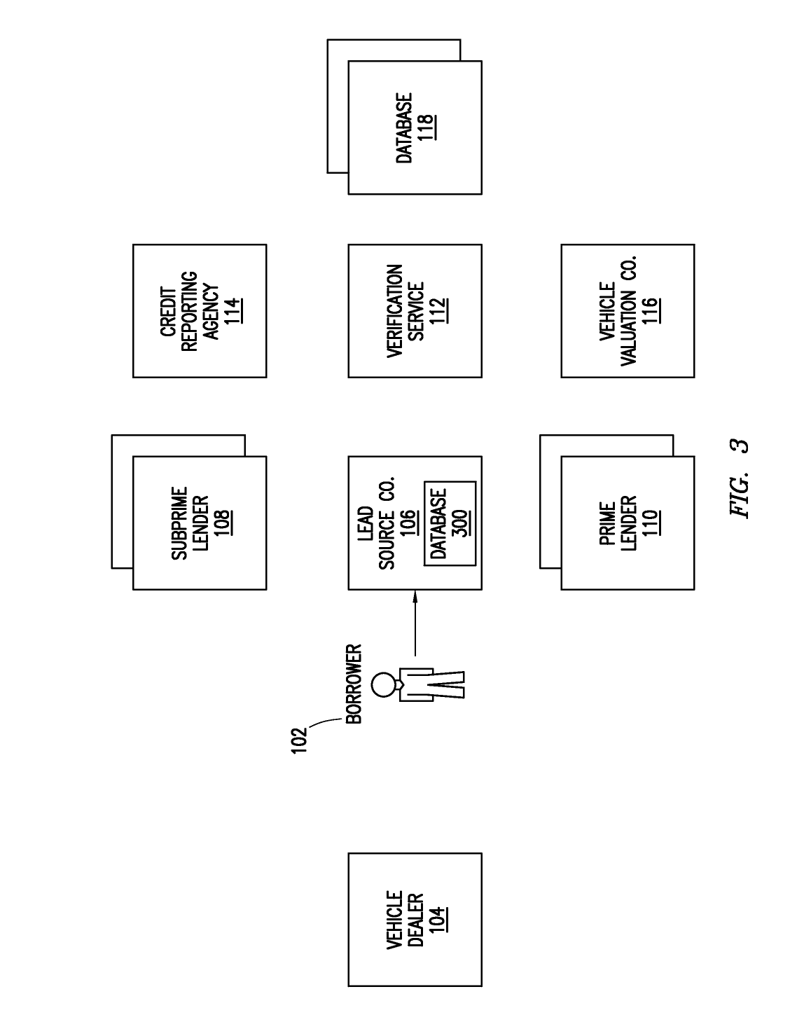

FIG. 3 shows, in block diagram form, the system of FIG. 1 modified to show flow of information from the borrower to the lead source company 106. In particular, from the perspective of borrower 102, the borrower 102 begins the financing process by filling out a vehicle loan application containing personal identifying information and financial information, thus creating a lead. In some cases, the borrower 102 may provide the lead to the lead source company 106 electronically, such as by filling out an application by way of a web browser. In other cases, the borrower 102 may provide the information to the lead source company 106 by calling a customer representative, to whom the information is conveyed verbally, and wherein the customer service representative keys the information into an electronic form. Further still, the borrower 102 may fill out a loan application with pen and paper, and send the loan application to the lead source company 106, where a data entry specialist may key the information into an electronic form.

A plethora of information may be provided on the loan application, such as the personal information shown in Table 1 below.

TABLE 1
Full Name
Social Security Number
Current Residential Address
Time at Current Residential Address
Date of Birth
Employment Status
Name of Employer
Address of Employer
Work Telephone Number
Personal Telephone Number (Wired Phone Number; Wireless Phone
Number)
E-mail Addresses
Current Residential Address
Time at Current Residential Address
Previous Residential Address
Time at Previous Residential Address
Citizenship
Marital Status
Military Rank
Number of Dependents

The personal information of Table 1 is merely an example, and other personal information may be required on the loan application.

In addition, the borrower 102 may provide financial information, such as the example financial information shown in Table 2 below:

TABLE 2
Monthly gross salary
Other monthly income
Value of liquid assets
Monthly housing payments
Credit score (if known)
Whether borrower has filed for bankruptcy, and if so when

Housing payments may be rent, or may be mortgage payments, including principal, interest, and private mortgage insurance; insurance premiums, property taxes, and homeowners association fees. If the borrower 102 is applying for the vehicle loan with a joint borrower, information related to the personal and financial information of the joint borrower (i.e., the information in Tables 1 and 2) may also be included on the loan application.

The loan application information is organized and saved in an electronic database 300 owned or controlled by the lead source company 106. Thus, the electronic database may be on a computer system local to the lead source company 106, or the electronic database may be on a remote computer, such as stored in cloud-based storage.

Initial Criteria

After the loan application has been received by the lead source company 106, in accordance with example embodiments, the loan application is applied to an initial lead filtering process based on predetermined initial criterion or initial criteria. In particular, the lead is discarded if the lead does not meet certain initial criteria. For example, the minimum age for entering into contracts (such as a contract for a loan or financing) in most states is 18 years of age. Thus, if the borrower 102 is under the age of 18 years in this example, and regardless of any of the other information provided by the borrower 102, the lead is discarded by the lead source company 106 for failing to meet an initial minimum threshold. Other initial criteria may be used for initial filtering, and initial filtering is not solely limited to age.

Verification of Information in the Loan Application

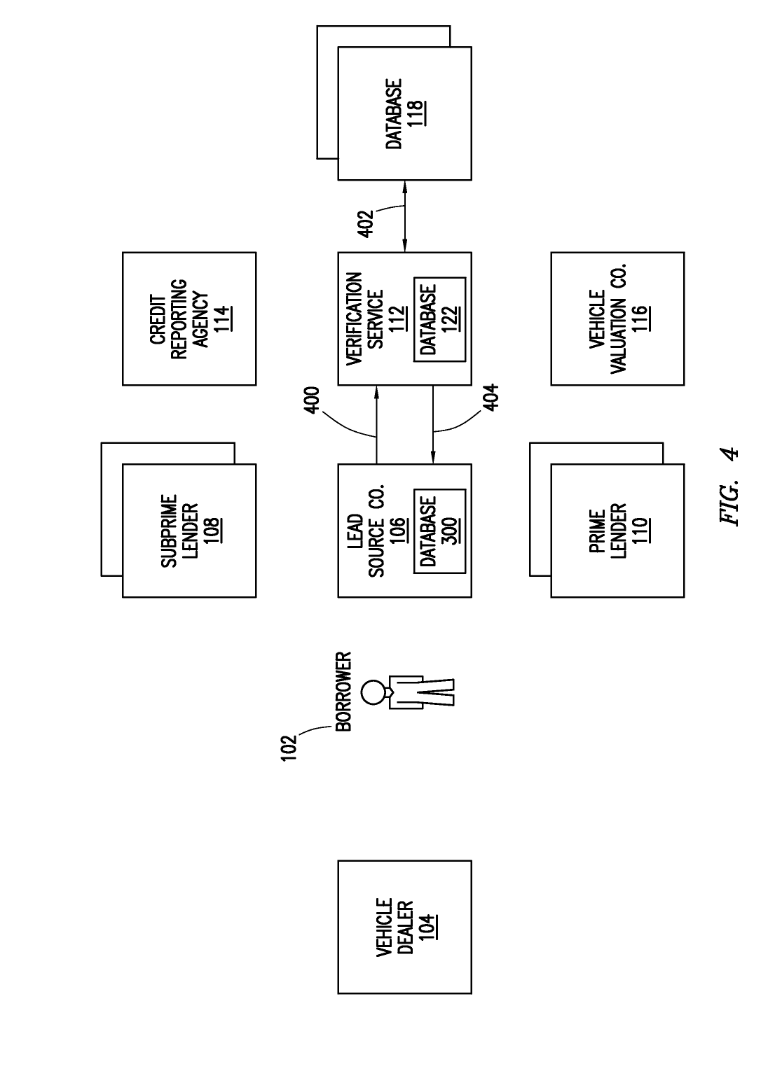

If the lead passes the initial filtering, in accordance with example embodiments, the lead source company 106 performs a verification process to determine the veracity (e.g., validity, accuracy, truthfulness) of the information provided in the lead. The specification thus turns now to FIG. 4 and a discussion of the lead verification process.

FIG. 4 shows, in block diagram form, the system of FIG. 1 modified to show flow of information from the lead source company 106 to the example verification service 112. In particular, FIG. 4 shows the communication between the lead source company 106 and a verification service 112. In accordance with example embodiments, after the lead source company 106 receives the lead from the borrower 102, the lead may be sent by to a third party verification service 112 (e.g., Neustar, Inc. performing verification services under the trademark NEUSTAR®, www.neustar.biz). The verification service 112 compares the information provided by the borrower 102 in the lead against information available from a variety of sources. In one embodiment, the verification service 112 may utilize internal, proprietary databases 122. In another embodiment, the verification service 112 may utilize a plurality of publicly available and/or fee-based databases 118. For example, verification service 112 may utilize publicly available address information related to the potential borrower 102 and compare that information to the addresses provided in the lead. If the potential borrower has provided addresses that do not match those in the databases, the addresses provided in the lead may be considered invalid. In another embodiment, the Social Security numbers are verified. In yet another embodiment, the phone numbers are verified. Regardless of which information from the lead is used in the verification process, the verification service 112 may assign a value indicative of veracity (hereafter just a veracity score) to the lead based on the validity of the information provided.

In one example, the veracity score may be a number between 0-10 inclusive; however, the range of numerical possibilities is not limited solely to 0-10. If the verification service 112 assigns a veracity score of 0 to the lead, that score indicates that very little information, if any, provided in the lead has matched the available information. On the other end of the range, the verification service may assign a veracity score of 10 to the lead. A veracity score of 10 may indicate that everything provided in the lead has been verified. Of course, in most cases the veracity score provided by the verification service will be between the lower and upper limits of the veracity score, with values closer to the upper limit indicating a higher likelihood of validity and values closer to the lower limit indicating a lower likelihood of validity.

In summary, the lead source company 106 may provide some or all the information of the lead to the verification service (as shown by arrow 400). In some cases the information is provided electronically, such as over the Internet, but any communication system may be used. The verification service 112 may refer to internal databases 112 and/or external databases 118 (as shown by double-headed arrow 402) to check the veracity of the statements in the lead. The verification service 112 may then provide the veracity score to the lead source company 106 (as shown by arrow 404).

While FIG. 4 shows that the veracity of the information is checked by a third-party source, in other cases the lead source company 106 may itself perform the veracity check and assign the veracity score to the lead.

Quality Criteria

After a veracity score is received or determined by the lead source company 106, the lead may go through a second filtering process by the lead source company 106. The second filtering process may be based on certain quality criteria as measured by the veracity score. In particular, the lead source company 106 may discard leads having a veracity score below a predetermined threshold. Thus, for example, any lead with a veracity score of 5 or less may be discarded in the second filtering process, and thus not provided to any lender.

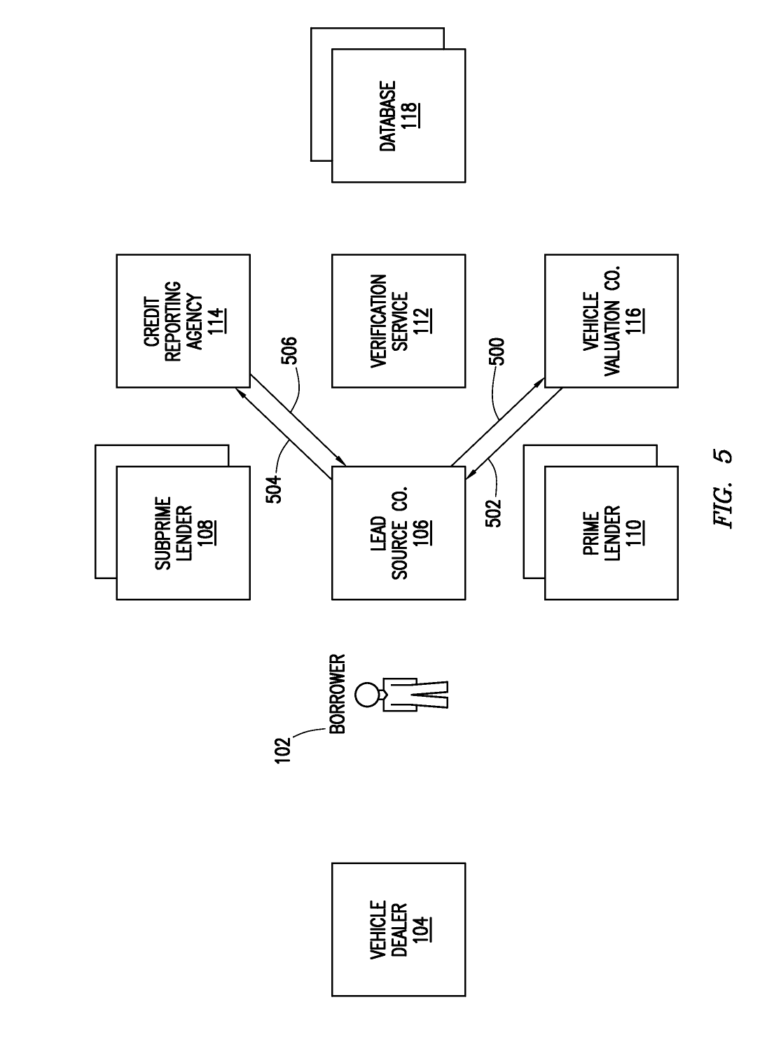

If the lead passes the quality criteria, the lead source company 106 may then gather further information, as discussed with respect to FIG. 5.

Vehicle Information

FIG. 5 shows, in block diagram form, the system of FIG. 1 modified to show flow of information between the lead source company 106, the credit reporting agency 114, and the vehicle valuation company 116. In particular, in gathering additional information related to the lead before matching the lead with one or more lenders, additional information related to the vehicle that borrower 102 desires to purchase is gathered. In particular, information about the desired vehicle (which information is in the loan application) is provided to an vehicle valuation company 116, such as Kelley Blue Book Co., Inc., of Irvine, Calif. Providing the information to the vehicle valuation company 116 is shown by arrow 500 of FIG. 5. The vehicle valuation company 116 obtains retail pricing by collecting information about actual retail sales, and then estimates a valuation based on information about the desired vehicle, such as make, model, year, condition, and miles driven. The vehicle valuation company 116 may return to the lead source company 106 a value or range of possible values for the car, returning the information shown by arrow 502.

The lead source company 106 may provide some or all the information of the lead to the vehicle valuation company 116 (again, the providing as shown by arrow 500) in any suitable fashion. In some cases the information is provided electronically, such as over the Internet, but any communication system may be used. Likewise, the vehicle valuation company 116 provides the valuation information to the lead source company (as shown by arrow 502) in any suitable fashion, such as over the Internet.

Borrower Credit Information

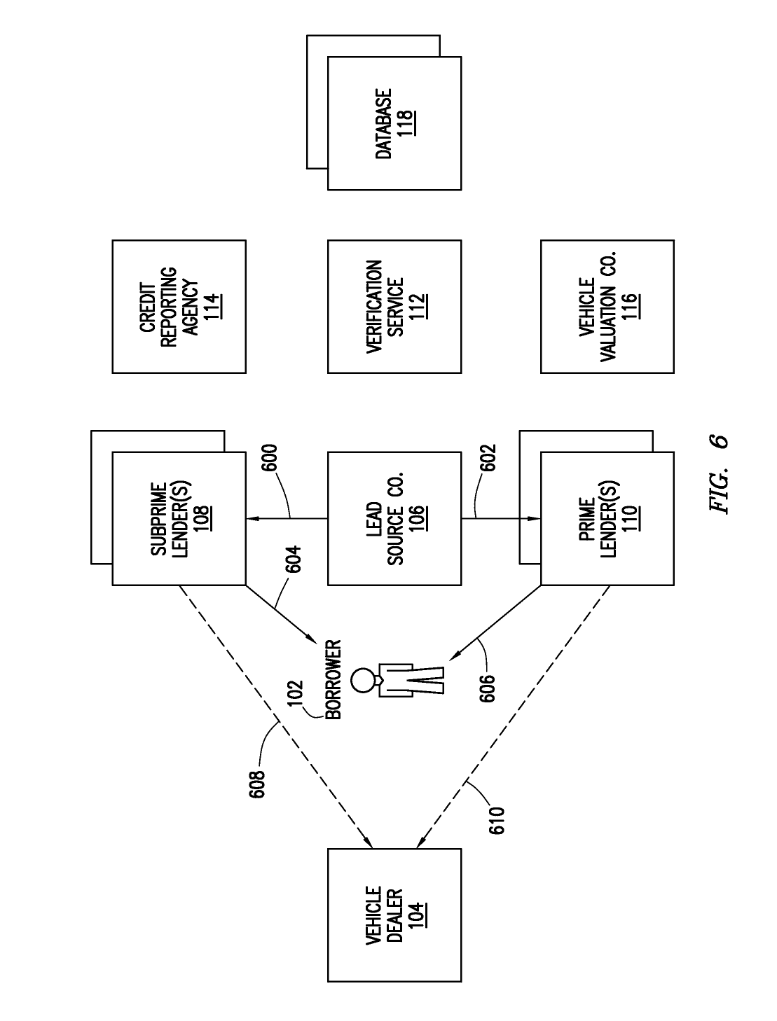

Still referring to FIG. 5, in addition to information about the vehicle, the lead source company 106 may request a credit report regarding the borrower 102 from a consumer reporting agency 114 or credit bureau (such as Experian, Equifax, or Trans Union). In particular, information about the borrower 102 (e.g., Social Security number), which information is in the loan application, is provided to credit reporting agency 114. Providing the information to the credit reporting agency 114 is shown by arrow 504 of FIG. 5. The credit reporting agency 114 may refer to internal and/or external databases of information (not expressly shown) to gather the requested credit information about the borrower. The credit reporting agency 114 may return to the lead source company 106 the credit information about the borrower 102, including the borrower's FICO score. Returning of the credit information is shown by arrow 506 of FIG. 6.

The consumer report may be analyzed and the borrower's creditworthiness, credit standing, and credit capacity determined. In part, the determination may include consideration of a FICO score and whether the potential borrower 112 has ever filed for bankruptcy.

The specification now turns to how the lead source company 106 uses the collected information to match lenders to the borrower 102.

Applying the Set of Criteria for Each Lender

Threshold Criteria

As discussed previously, each lender has provided a set of criteria to the lead source company 106, with each set of criteria including, in some cases, threshold criteria. Thus, in accordance with example methods and systems, the lead source company 106 may, for each lender of a group of lenders (e.g., prime lenders 110 and subprime lenders 108), apply the threshold criteria for each lender to the lead and/or the information gathered from the disparate sources of information (e.g., the verification service 112, the credit reporting agency 114, and the vehicle valuation company 116). For any lender for which the borrower does not meet one or more of the threshold criteria, the lender may be removed from the group of lenders being considered for the borrower. That is, in this filtering step the filtering is lender specific. Thus, while a lender may be removed from consideration for failing to meeting the threshold criteria of one lender, other lenders may remain for consideration based on having different threshold criteria.

For example, one lender may set a minimum threshold of one year at a current residence for its borrowers. Thus, if the lead indicates the borrower 102 has lived at his current residence for only six months, the lender will be removed from consideration for the particular borrower for failing to meet the threshold criteria set by lender. In another example, a second lending institution may have a threshold criterion of a credit score of 700. Thus, for each lead which has passed all of the previous filtering and verification steps, but has a credit score of less than 700, the particular lender will be removed from the group of lenders under consideration for matching with the borrower.

Balancing Criteria and the Lender Score

Now that the lead has been thoroughly filtered and verified by the lead score company 106, and the lead has been tested against the threshold criteria for each lender in the group of lenders, a lender score for each lender is created based on the lead and the gathered information. In particular, consider a single lender and that lender's set of criteria, and more particularly the lender's balancing criteria. The balancing criteria of the lender are evaluated against the lead and the gathered information. A numerical values is assigned with respect to each criterion of the balancing criteria, and the numerical values are summed to arrive at the lender score with respect to the particular borrower. The process is repeated for each lender in the group of lenders still under consideration, and thus a plurality of lender scores is created.

The following example is an example of calculating a lender score. Consider that a lender (e.g., one of the prime lenders 110) has provided balancing criteria to lead source company 106 as follows: (1) a credit score between 601-800; (2) borrower has lived at current residence for over a year, but preferably two years; and (3) borrower has a debt-to-income ratio of 1000/4000 (or 25%). For simplicity, only three criteria are expressly discussed, although the actual number of criteria which make up the score are likely to be many more. Moreover, it is noted that these example balancing criteria are also examples of threshold criteria, and thus the conceptual division between threshold criteria and balancing criteria need not result in two separate criteria lists. In determining the lender score for the example lender, the lead source company 106 may, algorithmically, assign numerical values to the each criterion to arrive at the lender score. For example, a point may be assigned for each of the qualifiers shown in Table 3 below.

TABLE 3
Credit score of 601-650 (1 point if in or over this range)
Credit score of 651-700 (1 point if in or over this range)
Credit score of 701-750 (1 point if in or over this range)
Credit score of 751+ (5 point)
Years at current residence (1 point per year over the first year)
Debt-to-income ratio (10 point for each quarter percentage over 25%, with
interpolation between quarter points)

Consider further that the borrower's information is as follows: credit score 720; lived at current residence 10 years; debt-to-income 50%. Applying the example guidelines of Table 3 to the borrower's information, the lender score for this particular lender would be the sum of: 1 point for the credit score being over 650; 1 point for the credit score being over 700; 1 point for the credit score being within the range of 701-750; 9 points for being at current residence for 10 years; and 10 points for the 50% debt-to-income ratio. Thus, for this example the lender score would be a value of 22. However, a second lender may value different information differently, and so for the same borrower (i.e., credit score 720; lived at current residence 10 years; debt-to-income 50%), the second lender may have a different lender score, such as 15, or 35.

Thus, a lender score is created for each lender (remaining in the group of lenders), the lender score based on the balancing criteria, the information from the lead, and the information gathered by the lead source company. The next step in the example methods and systems matching the lenders to the borrower based on the lender scores.

Matching Lenders to the Borrower

In accordance with example embodiments, not all lenders who have a lender score created are “matched” to the borrower. In particular, in example embodiments, a predetermined number of the lenders remaining in the group of lenders (i.e., those for which a lender score has been calculated) are selected, where the predetermined number of lenders is, in many cases, less than all the lenders (unless the number of lenders remaining is the same as the predetermined number). In some example cases, the predetermined number of lenders may be three, but one or more may be selected. In particular, a computer system owned or controlled by the lead source company 106 may programmatically select a predetermined number (e.g., three) of lenders based on the lender scores. In some cases, the lender scores having the highest values are selected (e.g., the three highest scores). However, lender scores may also be designed to show better correspondence between a lender and the borrower based on a lower score, and thus in other cases the lender scores having the lowest values are selected (e.g., the three lowest scores).

Turning to FIG. 6, FIG. 6 shows, in block diagram form, the system of FIG. 1 modified to show flow of information between the lead source company 106 and the lenders, as well as communication from the lenders to the borrower 102. Based on the selection of lenders, the lead source company 106 sends the lead to each selected lender. For example, if the selected lenders are all subprime lenders 108, the lead source company 106 sends the lead to the selected subprime lenders 108, as shown by arrow 600. If the selected lenders are all prime lenders 110, the lead source company 106 sends the lead to the selected prime lenders 110, as shown by arrow 602. It is possible that group of selected lenders includes both subprime and prime lenders, and thus the situations shown in FIG. 6 need not be viewed as mutually exclusive. The leads may be sent to the lenders in any suitable form, such as by electronic messages sent over the Internet.

Once the lenders have been provided the leads, each lender is responsible for contacting the borrower (as shown by arrows 604 and 606) and completing the process. If an agreement is made between a lender and the borrower 102, and a loan contract is executed, the lender may directly pay the vehicle dealer 104 (as shown by dashed lines 608 and 610).

In some cases, a lender may pay a flat fee amount to the lead source company for each every lead provided to the lender, regardless of whether the borrower 102 consummates the transaction with the lender. In other cases, the lender may pay an initial (probably reduced) amount for each lead provided to the lender, and then pay the lead source company 106 an additional fee if the borrower 102 consummates the transaction with the lender.

System Environment

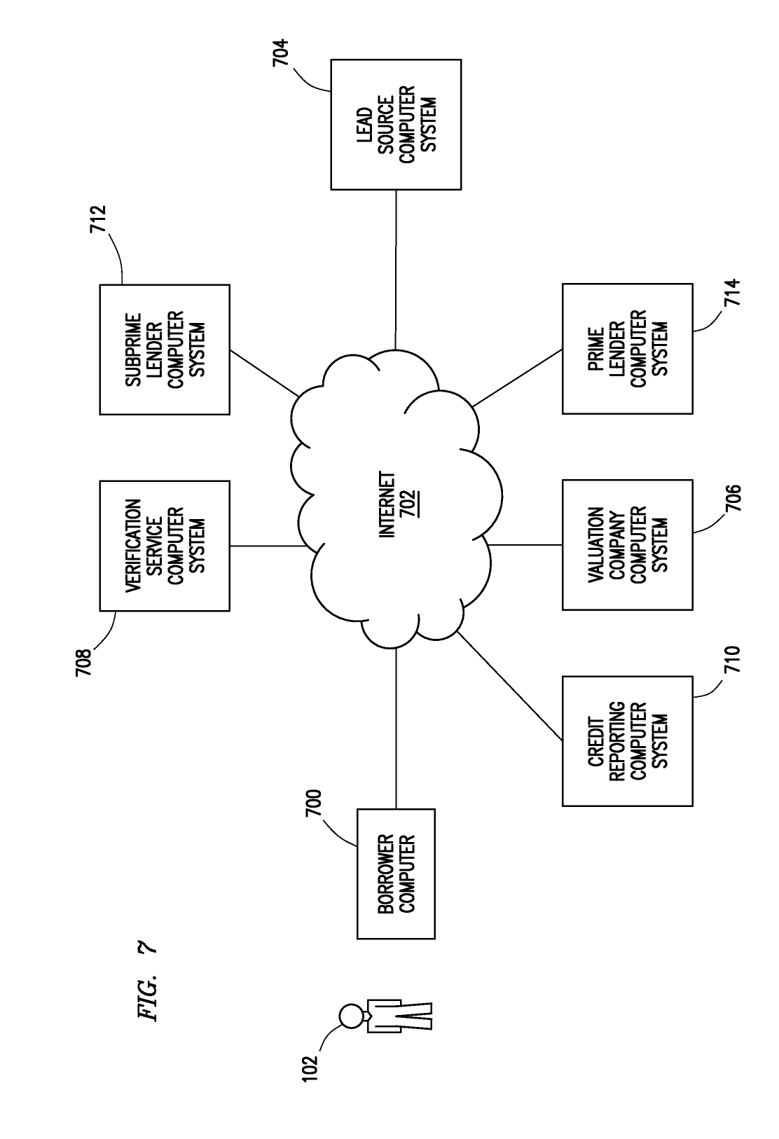

FIGS. 1-6 introduce the legal entities that may be involved in the example embodiments, and also introduce communications between such legal entities. FIG. 7 shows an example system environment in which the various example methods may be implemented. In particular, the borrower 102 may be associated with a borrower's computer system 700. The borrowers computer system 700 may be any suitable computer system that can access, display and interact with the web pages, such as desktop computer, a laptop computer, a smartphone, or a tablet device. In the example system, the borrower's computer system couples to a network, illustratively shown as the Internet 702.

The borrower's computer system 700 is communicatively coupled to lead source computer system 704. Lead source computer system 704 thus couples to the Internet, and is configured to provide interactive web pages to the borrower's computer system 700 (e.g., to accept loan applications), to communicate with various other service providers, and to perform the programmatic aspects the example embodiments. In some cases, the lead source computer system 704 is a desktop computer, but in other cases may be a server system and/or may be implemented as a “cloud” computer system, such that the exact location of the computer system may change over time or based on loading.

The example system further comprises a valuation company computer system 706 coupled to the Internet, and therefore communicatively coupled the other computer systems, such as the lead source computer system 704. In some cases, the valuation company computer system 706 is a desktop computer, but in other cases may be a server system and/or may be implemented as a “cloud” computer system, such that the exact location of the computer system may change over time or based on loading.

Still referring to FIG. 7, the example system further comprises a verification company computer system 708 coupled to the Internet, and therefore communicatively coupled the other computer systems, such as the lead source computer system 704. In some cases, the verification company computer system 708 is a desktop computer, but in other cases may be a server system and/or may be implemented as a “cloud” computer system, such that the exact location of the computer system may change over time or based on loading.

The example system further comprises a credit reporting computer system 710 coupled to the Internet, and therefore communicatively coupled the other computer systems, such as the lead source computer system 704. In some cases, the credit reporting computer system 710 is a desktop computer, but in other cases may be a server system and/or may be implemented as a “cloud” computer system, such that the exact location of the computer system may change over time or based on loading.

The example system further comprises a subprime lender computer system 712 coupled to the Internet, and therefore communicatively coupled the other computer systems, such as the lead source computer system 704. In some cases, the subprime lender computer system 712 is a desktop computer, but in other cases may be a server system and/or may be implemented as a “cloud” computer system, such that the exact location of the computer system may change over time or based on loading.

Finally, the example system further comprises a prime lender computer system 714 coupled to the Internet, and therefore communicatively coupled the other computer systems, such as the lead source computer system 704. In some cases, the prime lender computer system 714 is a desktop computer, but in other cases may be a server system and/or may be implemented as a “cloud” computer system, such that the exact location of the computer system may change over time or based on loading.

Thus, the borrower's computer system 700 may communicate with the lead source computer system 704. The lead source computer system 704 may communicate with the various service providers (e.g., validation company computer system 706, verification service computer system 708, credit reporting computer system 710, subprime lender computer system 712, or prime lender computer system 714) to perform the various methods described in this specification.

Flow Diagram

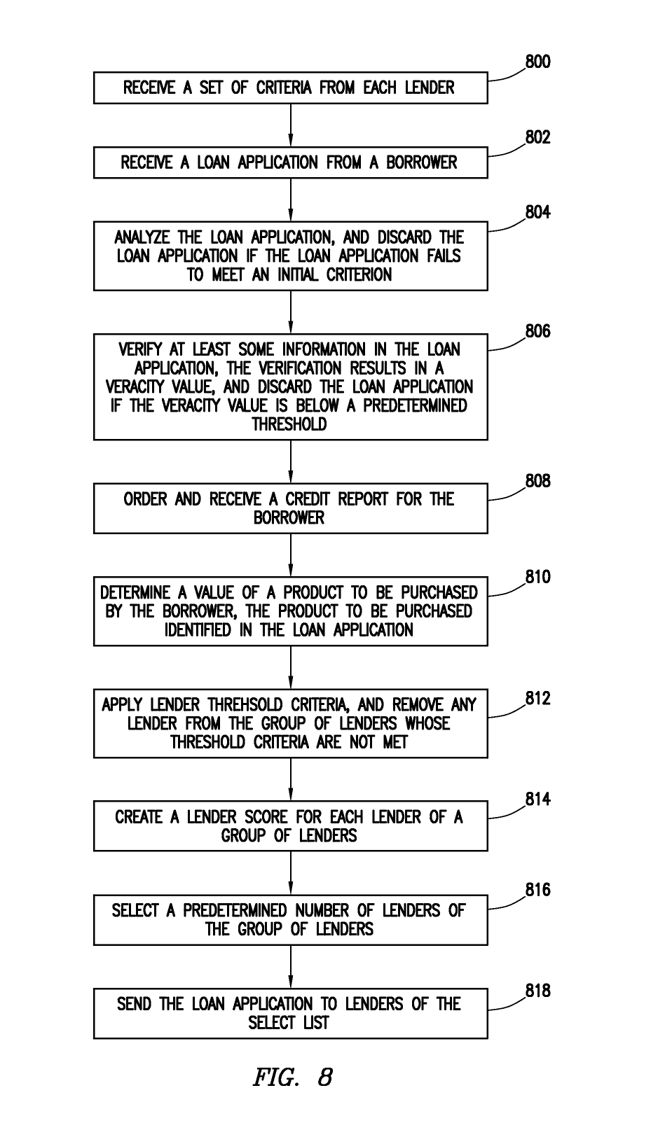

FIG. 8 shows a flow diagram in accordance with at least some embodiments. All of the steps discussed in the flow diagram may be implemented on the lead source computer system 704. All the example steps have been discussed in reference to FIGS. 1-6; however, the flow diagram is presented to conceptually tie together the various example embodiments. In particular, the method may start by the lead source computer system receiving a set of criteria from each lender (block 800). The set of criteria may include not only the threshold criteria, but also the balancing criteria. In many cases the lenders will provide their respective sets of criteria electronically (e.g., email, filling out an interactive web-based form provided from the lead source computer system 704).

Next the example method may comprise the lead source computer system 704 receiving a loan application from a borrower (block 802). The lead source computer system 704 may then analyze the loan application, and discard the loan application if the application fails to meet initial criteria (block 804). If the loan application meets the initial criteria, the next step performed by lead source computer system 704 may be to verify at least some of the information in the loan application, resulting in a veracity value (block 806). The loan application may be discarded if the veracity value is below a predetermined threshold (again block 804). Verifying at least some information of the loan application may involve the lead source computer system 704 communicating with the verification service computer system 708.

If the loan application passes the verification analysis (again block 806), the next step in the illustrative method may be to order and receive a credit report of the borrower (block 808). The lead source computer system 704 may obtain the credit report by communicating with the credit reporting computer system 710. Moreover, the lead source computer system 704 may determine a value of the product to be purchased by the borrower as identified in the loan application (block 810). The lead source computer system 704 may obtain the value of the product by communicating with the valuation computer system 706.

Still referring to FIG. 8, once the various information has been gathered by the lead source computer system 704, the lead source computer system 704 may apply lender threshold criteria, and remove any lender from the lender group whose threshold criteria are not met (block 812). With regard to the remaining lenders, the lead source computer system 704 calculates a lender score for each lender (block 814), and selects a predetermined number of lenders from the group of lenders based on the lender scores (block 816). Thereafter, the lead source computer system 704 sends the loan application to the lenders on the select list of lenders (block 818), and the process ends, likely to be immediately restated for the next borrower.

While the example flow diagram of FIG. 8 shows the method performed linearly, many of the steps may be performed in parallel. For example, any or all of verifying the veracity, ordering the credit report, and/or determining the value of product could be performed simultaneously.

Example Computer System

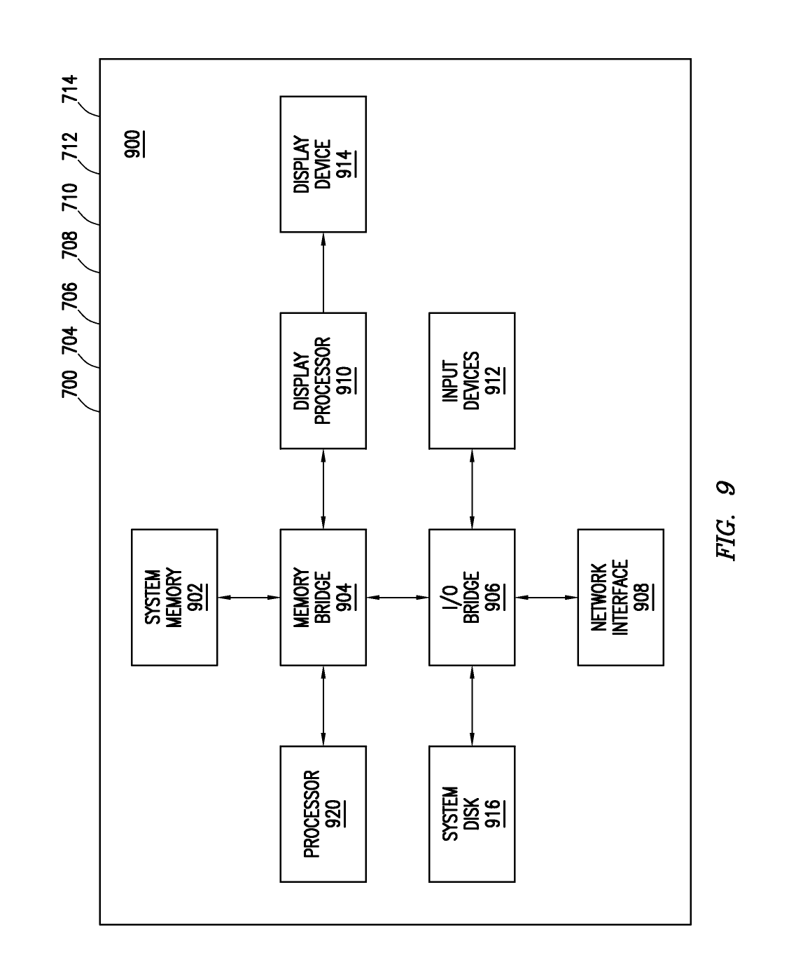

FIG. 9 shows, in block diagram form, a computer system 900 in accordance with at least some embodiments. The computer system 900 may be illustrative of, for example borrower's computer system 700, lead source computer system 704, valuation company computer system 706, verification company computer system 708, credit reporting computer system 710, subprime lender computer system 712, and/or prime lender computer system 714. Computer system 900 comprises a central processing unit (CPU) 920 coupled to a system memory 902. CPU 920 may comprise a processor 919.

System memory 902, which is connected to CPU 920 by way of memory bridge 904, functions as the working memory for the CPU, and comprises a memory device or array of memory devices in which programs, instructions and data are stored. System memory 902 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM). System memory 902 is an example of a non-transitory computer-readable medium storing programs and instructions, and other examples of a non-transitory computer-readable medium may include disk drives (e.g. hard drives or solid-state drives) and flash memory devices.

Memory bridge 904 is also connected to an input/output (I/O) bridge 906 via a bus or other communication path. The I/O bridge 906 controls many computer system functions, such as interfacing with various input devices 912, (e.g., a keyboard, mouse, game controller, serial ports, floppy drives, and disk drives). Further, I/O bridge 906 may be coupled to a network interface 908, which enables computer system 900 to communicate with other computer systems via an electronic communications network, and may include wired or wireless communication over local area networks, wide area networks, and/or the Internet. Other components, including universal serial bus (USB) ports or other communication port connections (e.g., RS323, RS485, Fire Wire) may also be supported by the I/O bridge 906.

The computer system 900 further comprises a display processor 910 which, in the example system of FIG. 9, is coupled to the memory bridge 904. In one embodiment, display processor 910 is a graphics subsystem that includes at least one graphics processing unit (GPU) and graphics memory. Display processor 910 couples to display device 914. The graphics processing unit (which may be part of display processor 910) may comprise an onboard processor, as well as onboard memory (not shown as to not unduly complicate the figure). The onboard processor may perform graphics processing, as commanded by CPU 920.

System disk 916 is coupled to I/O bridge 906 and may be configured to store content, applications, and data for use by CPU 920. System disk 916 provides non-volatile storage for applications and data and may include fixed or removable hard disk drives, flash memory devices, and other magnetic, optical, or solid state storage devices. Computer system 900 may include, but is not limited to, personal desktop computers, servers, smartphones, web enabled television, tablet computers, or any other device having web browser software and a network interface.

It is noted that while theoretically possible to perform some or all the calculations discussed above by a human using only pencil and paper, the time measurements for human-based performance of such tasks may range from man-hours to man-years, if not more. Thus, this paragraph shall serve as support for any claim limitation now existing, or later added, setting forth that the period of time to perform any task described herein less than the time required to perform the task by hand, less than half the time to perform the task by hand, and less than one quarter of the time to perform the task by hand, where “by hand” shall refer to performing the work using exclusively pencil and paper.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. For example, while the various embodiments have been described in terms of matching lending institution with validated leads for the purpose of providing financial for a vehicle purchase. This context, however, shall not be read as a limitation as to the scope of one or more of the embodiments described—the same techniques may be used for other embodiments. It is intended that the following claims be interpreted to embrace all such variations and modifications.

The above discussion is meant to be illustrative of the principles and various embodiments of the present invention. Numerous variations and modifications will become apparent to those skilled in the art once the above disclosure is fully appreciated. For example, the example methods and systems may be applicable to purchase or refinance of any product, such as a house or boat. It is intended that the following claims be interpreted to embrace all such variations and modifications.

What is claimed is:

1. A method comprising:
receiving, by a computer system, a loan application submitted by a borrower;
creating, by the computer system, a lender score for each lender of a group of lenders, each lender score based on information within the loan application and a set of criteria provided by each lender of the group of lenders;
sending, by the computer system, the loan application to a predetermined number of lenders of the group of lenders, the lenders to whom the loan application is sent selected based on the lender score of each lender, and the predetermined number being less than all the lenders in the group of lenders.

2. The method of claim 1 further comprising, prior to creating, removing a first lender from the group of lenders, the removing based on the borrower failing to meet a threshold criteria of the first lender, the removing by the computer system.

3. The method of claim 1 further comprising:
verifying, by the computer system, information in the loan application, the verification creates a value indicative of veracity; and
wherein creating the lender score for each lender further comprises creating the lender score for each lender based on the value indicative of veracity.

4. The method of claim 1 further comprising:
obtaining, by the computer system, a credit report for the borrower; and
wherein creating the lender score for each lender further comprises creating the lender score for each lender based on the credit report of the borrower.

5. The method of claim 1 further comprising:
obtaining, by the computer system, a value of a product to be purchased by the borrower, the product to be purchased identified in the loan application; and
wherein creating the lender score for each lender further comprises creating the lender score for each lender based on the value of the product.

6. The method of claim 5 wherein obtaining the value further comprises obtain a value of a vehicle identified in the loan application.

7. The method of claim 5 further comprising:
verifying, by the computer system, information in the loan application, the verification creates a value indicative of veracity;
obtaining, by the computer system, a credit report for the borrower; and
wherein creating the lender score for each lender further comprises creating the lender score for each lender based on the value of the product, the value indicative of veracity, and information in the credit report of the borrower.

8. The method of claim 1 wherein creating the lender score for each lender further comprises assigning numerical values for each criterion of a set of criteria based on whether the borrower meets each criterion in the set of criteria.

9. The method of claim 1 wherein creating the lender score for each lender further comprises assigning a numerical value for a criterion of a set of criteria based on whether a creditworthiness value regarding the borrower falls within in a range of values defined by the criterion.

10. A computer system comprising:
a processor;
a memory coupled to the processor;
a network interface coupled to the processor;
said memory storing a program that, when executed by the processor, causes the processor to:
receive a loan application from a borrower, the receiving over the network interface;
analyze the loan application, and discard the loan application if the loan application fails to meet an initial criterion;
create a lender score for each lender of a group of lenders, each lender score based on information within the loan application and a set of criteria provided by each lender of the group of lenders;
select a predetermined number of lenders of the group of lenders, the lenders selected based on the respective lender score, and the predetermined number being less than all the lenders in the group of lenders, the selection creates a select list; and
send the loan application to lenders of the select list.

11. The computer system of claim 10 wherein when the processor analyzes the loan application, the program causes the processor to:
verify at least some information in the loan application, the verification results in a value indicative of veracity; and
discard the loan application if the value indicative of veracity is below a predetermined threshold.

12. The computer system of claim 11 wherein when the processor verifies information in the loan, the program causes the processor to:
send a message over the network interface; and
receive the value indicative of veracity of loan application, the receipt over the network interface.

13. The computer system of claim 11 wherein if the value indicative of veracity is above a predetermined threshold, the program causes the processor to:
order and receive a credit report for the borrower, the order and receipt over the network interface; and
wherein when the processor creates the lender score for each lender of the group of lenders, the program further causes the processor to create the lender score for each lender in the group of the lenders based on the credit report of the borrower.

14. The computer system of claim 11 wherein if the value indicative of veracity is above a predetermined threshold, the program causes the processor to:
determine a value of a product to be purchased by the borrower, the product to be purchased identified in the loan application; and
wherein when the processor creates the lender score for each lender of the group of lenders, the program further causes the processor to create the lender score for each lender in the group of the lenders based on the value of the product.

15. The computer system of claim 14 wherein when the processor determines the value of the product, the program causes the processor to communicate with a third-party service, the communication over the network interface.

16. The computer system of claim 10 wherein when the processor creates the lender score for each lender, the program causes the processor to assign numerical values for each criterion of a set of criteria based on whether the borrower meets each criterion in the set of criteria.

17. The computer system of claim 10 wherein when the processor creates the lender score for each lender, the program cause the processor to assign a numerical value for a criterion of a set of criteria based on whether a creditworthiness value regarding the borrower falls within in a range of values defined by the criterion.

18. A method comprising:
receiving, by a computer system, a loan application submitted by a borrower;
creating, by the computer system, a lender score, the first lender score based on information within the loan application and a first set of criteria provided by a first lender;
creating, by the computer system, a second lender score, the second lender score based on the loan application and a second set of criteria provided by a second lender, the second set of criteria different than the first set of criteria, and the second lender different than the first lender;
creating, by the computer system, a third lender score, the third lender score based on the loan application and a third set of criteria provided by a third lender, the third set of criteria different than the first and second set of criteria, and the third lender different than the first and second lender;
sending, by the computer system, the loan application to a predetermined number of the lenders, the lenders to whom the loan application is sent selected based on the lender score of each lender, and the predetermined number being less than all the lenders.

19. The method of claim 18 further comprising, prior to creating, removing a fourth lender from further consideration, the removing based on the borrower failing to meet a threshold criteria of the fourth lender, and the removing by the computer system.

20. The method of claim 18 further comprising:
verifying, by the computer system, information in the loan application, the verification creates a value indicative of veracity; and
wherein creating the lender scores further comprises creating the lender scores based on the value indicative of veracity.

21. The method of claim 18 further comprising:
obtaining, by the computer system, a credit report for the borrower; and
wherein creating the lender scores further comprises creating the lender scores based on the credit report of the borrower.

22. The method of claim 18 further comprising:
obtaining, by the computer system, a value of a product to be purchased by the borrower, the product to be purchased identified in the loan application; and
wherein creating the lender scores further comprises creating the lender scores based on the value of the product.

23. The method of claim 22 wherein obtaining the value further comprises obtain a value of a vehicle identified in the loan application.

24. The method of claim 22 further comprising:
verifying, by the computer system, information in the loan application, the verification creates a value indicative of veracity;
obtaining, by the computer system, a credit report for the borrower; and
wherein creating the lender scores lender further comprises creating the lender scores based on the value of the product, the value indicative of veracity, and information in the credit report of the borrower.

25. The method of claim 18 wherein creating the lender scores further comprises assigning numerical values for each criterion of a set of criteria based on whether the borrower meets each criterion in the set of criteria.
